(19) United States
(12) Patent Application Publication
(10) Pub. No.: US 2015/0134955 A1
(43) Pub. Date: May 14, 2015

(54) Method for Using Cryptography to Protect Deployable Rapid On-Site Manufacturing 3D Printing Systems and Enable a Single Time Printing Protocol

(71) Applicants: Alberto Daniel Lacaze, Potomac, MD (US); Karl Nicholas Murphy, Rockville, MD (US)

(72) Inventors: Alberto Daniel Lacaze, Potomac, MD (US); Karl Nicholas Murphy, Rockville, MD (US)

(21) Appl. No.: 14/540,003

(22) Filed: Nov. 12, 2014

Related U.S. Application Data
(60) Provisional application No. 61/903,363, filed on Nov. 12, 2013.

(51) Int. Cl. H04L 9/32; H04L 9/08

(52) U.S. Cl. CPC H04L 9/32; H04L 9/3234; H04L 9/08; H04L 9/3247
USPC 713/168

(57) ABSTRACT

A webserver is comprised of a registry, database, web store, arbiter, and signature verifier with device public keys. An external trusted machine provides a first key pair to the server system. The database contains encrypted copies of developer software/models, using the Trusted Machine to encrypt. The Signature Verifier verifies that devices requesting code are truly safe devices provided from a third party. The Trusted Machine is an extremely secure machine with a first key pair “A” used to encrypt and decrypt entries into the database safely. A trusted module is associated with the printer which comprises a random sequence generator. The printer generates keys required for printing and authorization using a Common Access Card (CAC). Next the server would encrypt the model with the keys generated by the trusted module of the printer to allow for the printer to decrypt the keys and effectuate printing of the encrypted model.

### CROSS REFERENCE TO RELATED APPLICATIONS

This application claims priority from U.S. Provisional Patent Application Ser. No. 61/903,363, entitled “A Method for Using Cryptography to Protect Deployable Rapid On-Site Manufacturing 3D Printing Systems and Enable a Single Time Printing Protocol”, filed on 12, Nov. 2013. The benefit under 35 USC §119e of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to rapid prototyping using 3D printers. More specifically, the present invention relates to rapid prototyping using 3D printers whereby access to the software and hardware to control the number of prints.

### BACKGROUND OF THE INVENTION

3D printing provides the ability for any user to print the products stored in a database at any location. The problem with 3D printing from a developer perspective is that of controlling the use of the models/products and the number of prints made by a user purchasing the rights to one or more prints.

What is needed is a system and method for controlling the distribution and protecting the developer's content from unauthorized manufacturing. Such a system could be one that controls the number of prints.

### SUMMARY OF THE INVENTION

The present invention teaches a system and method to create distributed software which enables access to software/hardware packages while protecting the content. This is accomplished using a scheme of encryption, verification, and trust. The application of the system and method of the present invention enables and encourages crowd sourced design by protecting the intellectual property of the developers.

A trusted module is associated with the printer which comprises a random sequence generator. The printer will generate the next keys required for printing and authorization using a Common Access Card (CAC). Next the server would encrypt the model with the keys generated by the trusted module of the printer to allow for the printer to decrypt the keys and effectuate printing of the encrypted model. This would limit printing of the model file sent from the Rapid Prototyping Library to the printer to only that specific printer. If the model file was copied or hijacked during transmission, it would be unable to be executed or printed by any other 3D printer as there would be no printer authentication to unlock the file for use as any other printer, even with a trusted module would be unable to decrypt the file due to the missing encryption keys.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 is a flow chart illustrating the process on the software side of the present invention;

FIG. 2 is a flow chart illustrating the security features of the present invention;

FIG. 3 is a flow chart illustrating the asymmetric encryption;

FIG. 4 is a flow chart illustrating the signing and verification process;

FIG. 5 is an overview of the server system;

FIGS. 6-10 illustrate on exemplary embodiment of the present invention from the developer side;

FIGS. 11-17 illustrate on exemplary embodiment of the present invention from the device side; and

FIG. 18 illustrated the single printing protocol of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

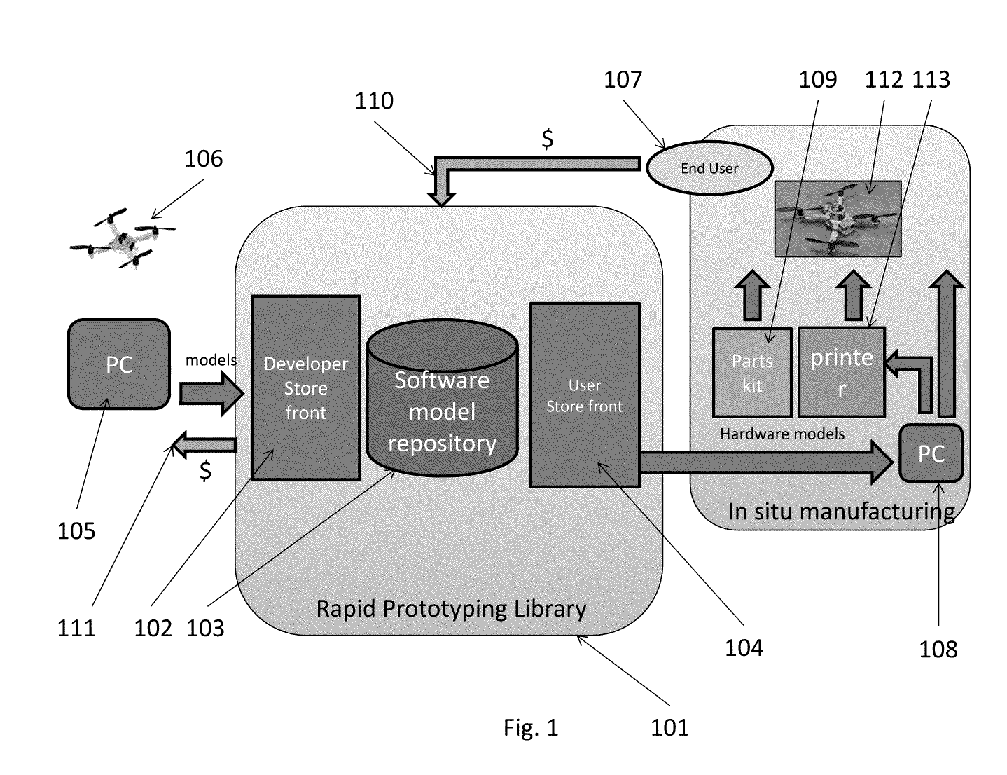

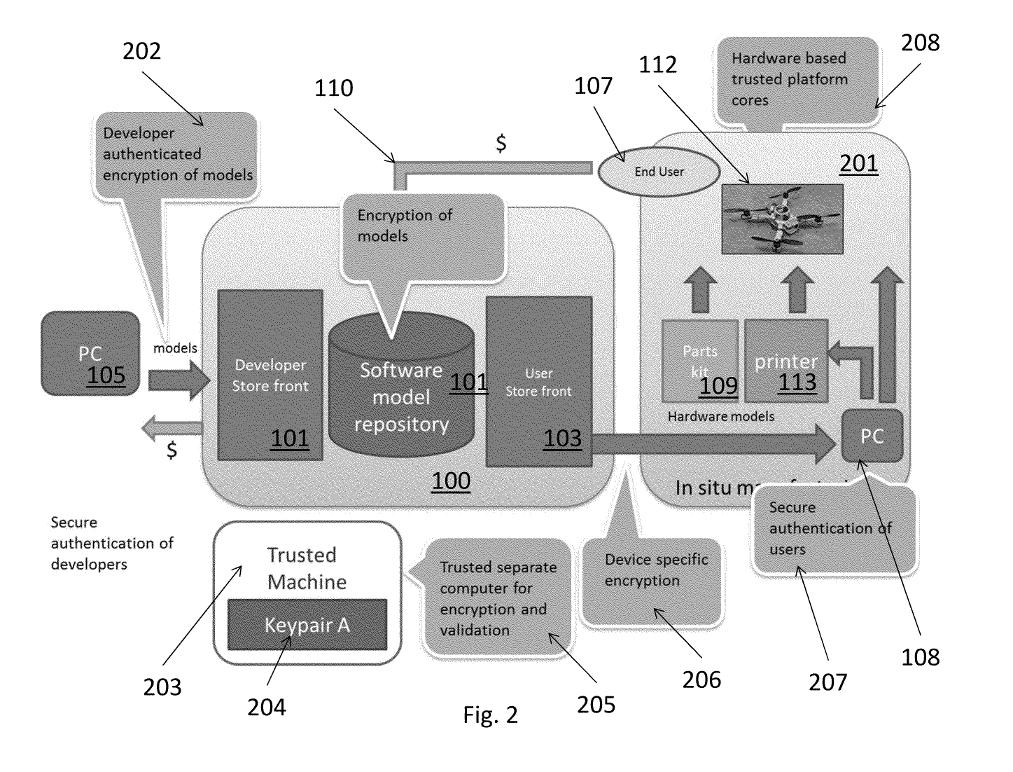

Referring to FIG. 1, a rapid prototyping library 101 is comprised of a developer store front 102, software model repository 103, and user store front 104. The developer store front 102 interacts with external computer 105 to send and receive models 106, which are stored in the software model repository 103 and presented to end users 107 via the user store front 104. Developers interact directly with the developer store front 102 to receive payment 110 based on the number of printsl 12 made by an end user's printer 113 from each of their models purchased by an end user 107. An end user 107 visits the user store front 104 and accesses it using a computer 108 to select their desired models 106. The end user then provides computer and 3D printer hardware at their own location from the production of the purchases models. Optionally, the end user may also be provided a parts kit 109 for use with or in combination with printed models. Payment 110 is sent by the end user 107 to the rapid prototyping library 101 for processing to the developer 111.

The system is vulnerable to attached in several different ways. First, unauthorized access could occur to the models/software inside the rapid prototyping library 100. Second, one could impersonate a developer to gain access to the rapid prototyping library 100. Third, unauthorized requests could be mad to the rapid prototyping library 100 from the end user side of the system 201. Fourth, a printed device 112 could be captured or stolen. Fifth, software form the rapid prototyping library 100 could be captured during transmission and used on an unauthorized device. Sixth, payment 110 could be withheld or not completed after the transaction. Seventh, unauthorized access to a container in the battlefield could be compromised or fall in to enemy hands, where access to the printing hardware and software is uncontrolled as is access to the rapid prototyping library 100 from previously authenticated equipment.

The present invention teaches several ways that the anticipated security breaches can be resolved. This method can also be applied in a commercial or residential setting, but is exemplified in the battlefield for purposed of illustration and explanation.

First, developers will be secured using standard authentication protocols 202. All models will be authenticated and encrypted before being stored in the rapid prototyping library 100. A separate trusted machine 203 will issue a first key pair 204 for verification between the rapid prototyping library 100 and the end user hardware 201. This trusted, separate machine 203 provides the computing power for encryption and validation services to the system 205. Upon transmission from the rapid prototyping library 100 to an end user computer 108, device specific encryption 206 is transmitted so that only the receiving device 108 can execute the software and model being transmitted. The end user's computer 108 provides secure authentication of users 207 to ensure that the user of the machine is authorized. The printed components and devices 1112 are provided with hardware based trusted platform cores 208 so that parts can only be recognized and controlled in specific combinations.

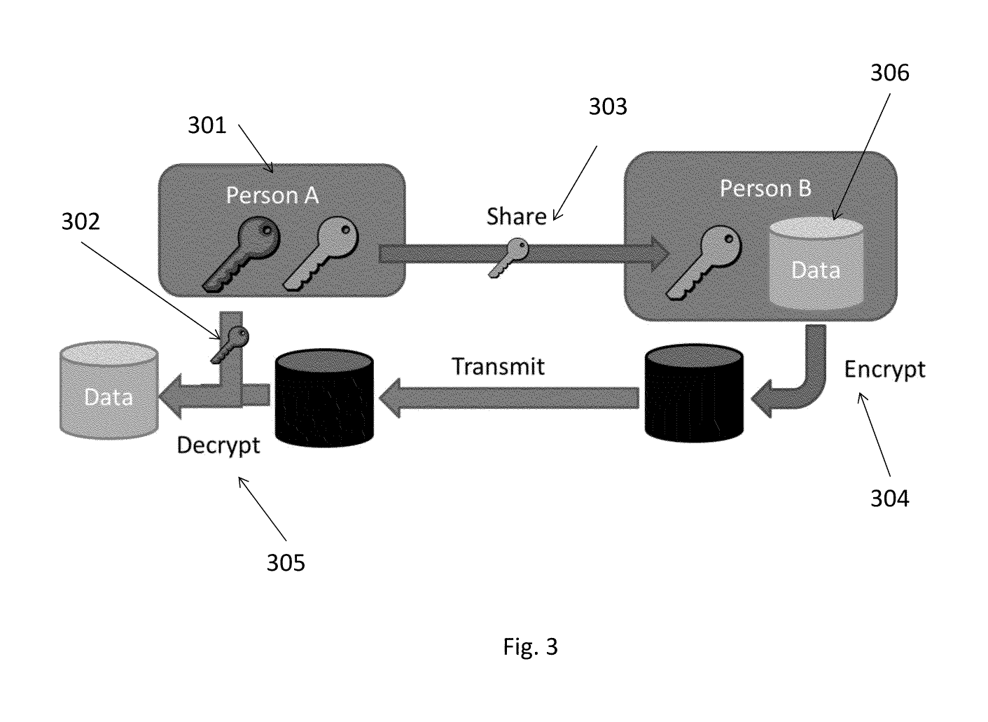

As shown in FIG. 3, asymmetric encryption, also known as public-key encryption will be used to protect the data. A special key pair 301 is created, one public and one private. The private key 302 is kept safe by the person decrypting the data 306, while the public key 303 is sent out to an end user. Anybody can encrypt 304 data with this public key 303 but it can only be decrypted 305 by the person with the private key 302.

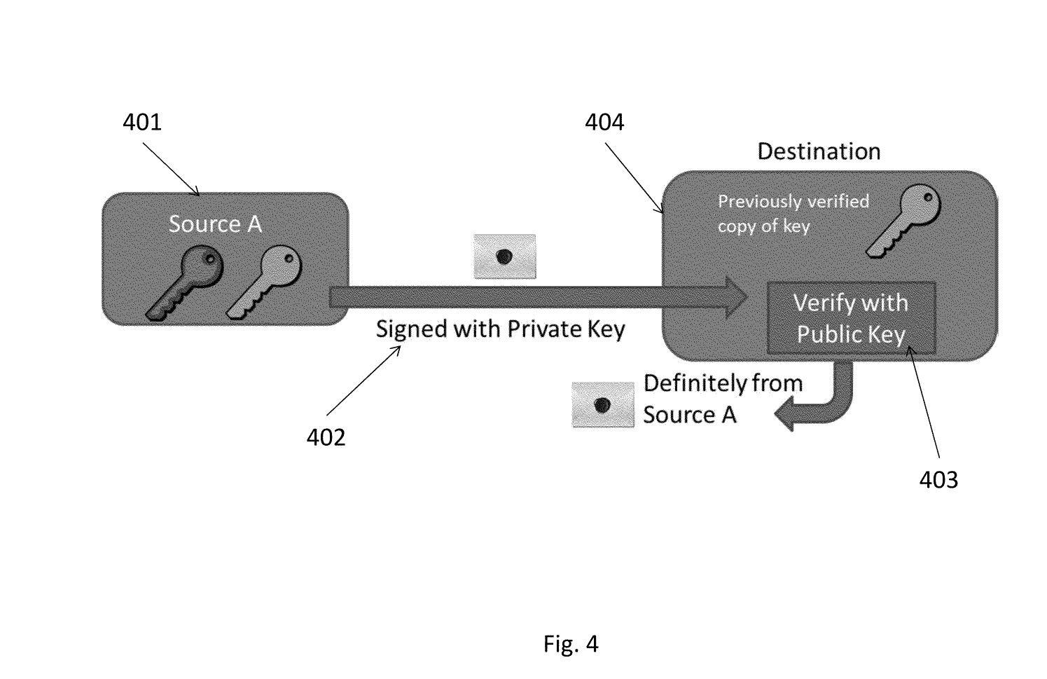

Signing uses different algorithms than encryption but similar keys. A source 401 can sign data with a private key 402 and the signature can be verified with the public key 403. If the destination 404 trusts the public key, then they can trust that the corresponding signature is valid as shown in FIG. 4.

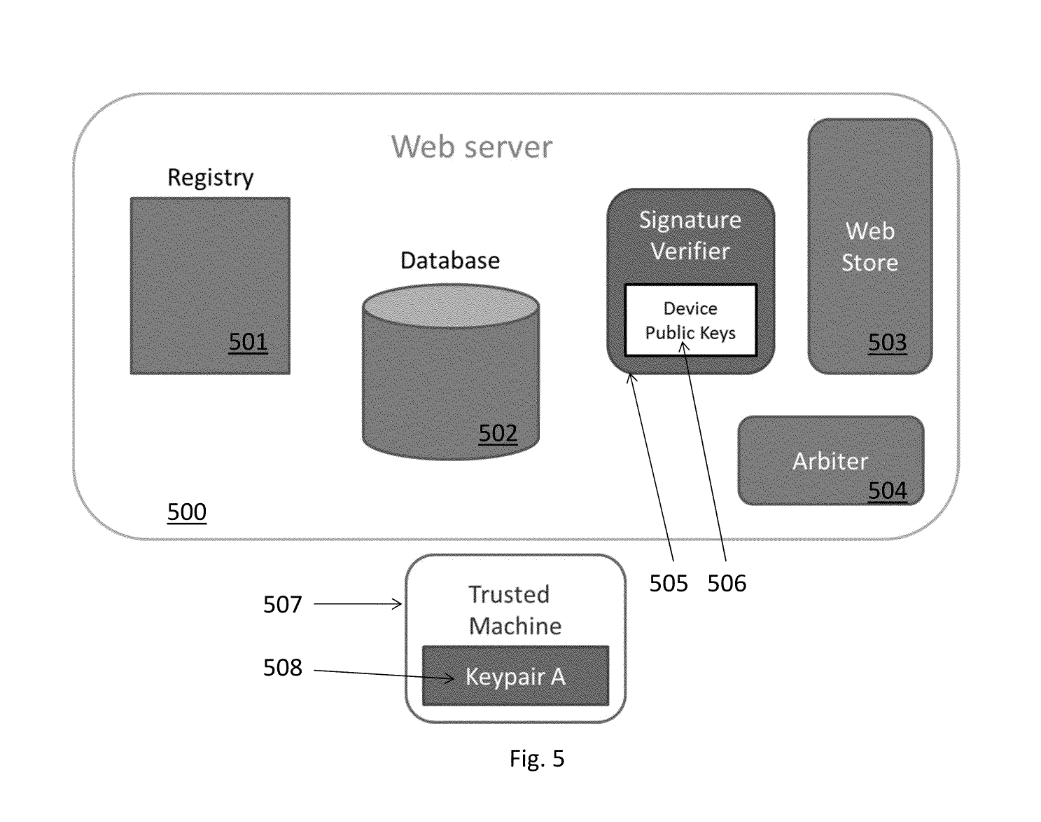

An overview of the sever system is show in FIG. 5, where the webserver 500 is comprised of a registry 501, database 502, web store 503, arbiter 504, and signature verifier 505 with device public keys 506. A trusted machine 507 providing a first key pair 508 is external to the server system 500. The registry 501 holds developer registration information, including public keys 506. The database 502 contains encrypted copies of developer software/models, using the Trusted Machine 507 to encrypt. The Signature Verifier 505 is used to verify that devices requesting code are truly safe devices provided from a third party. The Trusted Machine 507 is an extremely secure machine with a first key pair “A” 508 used to encrypt and decrypt entries into the database 502 safely. The Web Store 503 is the web frontend where users may browse and download new models/software. The Arbiter 504 is the software which handles software requests, encryption and signature commands, and database functions.

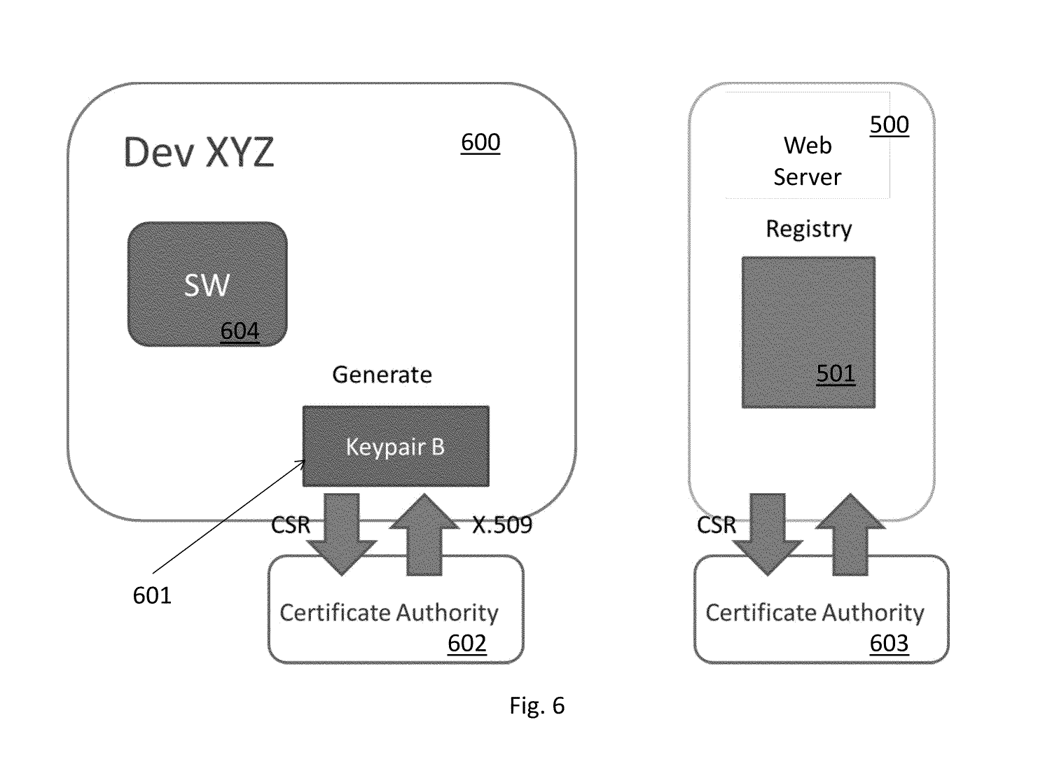

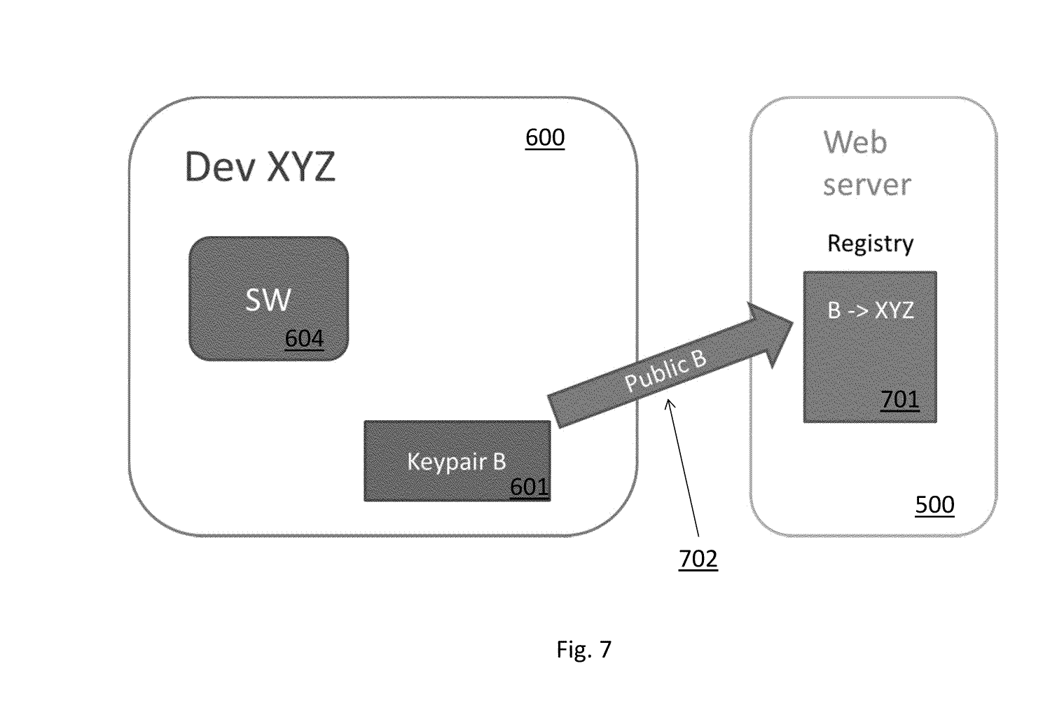

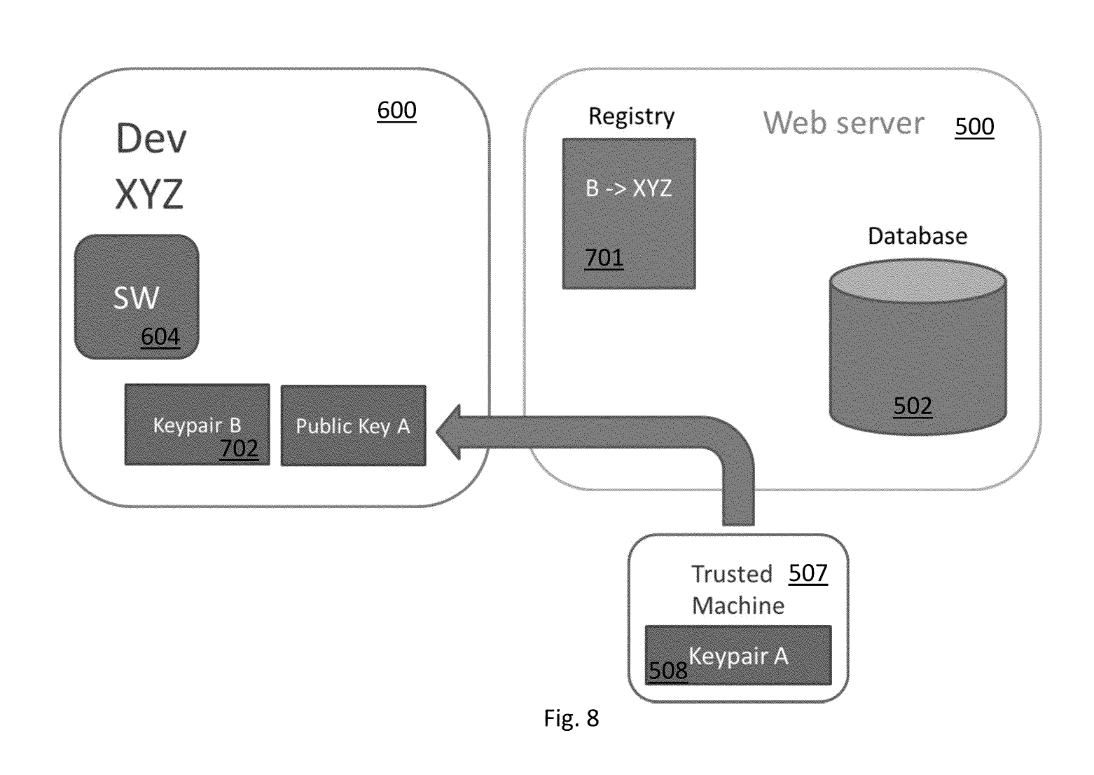

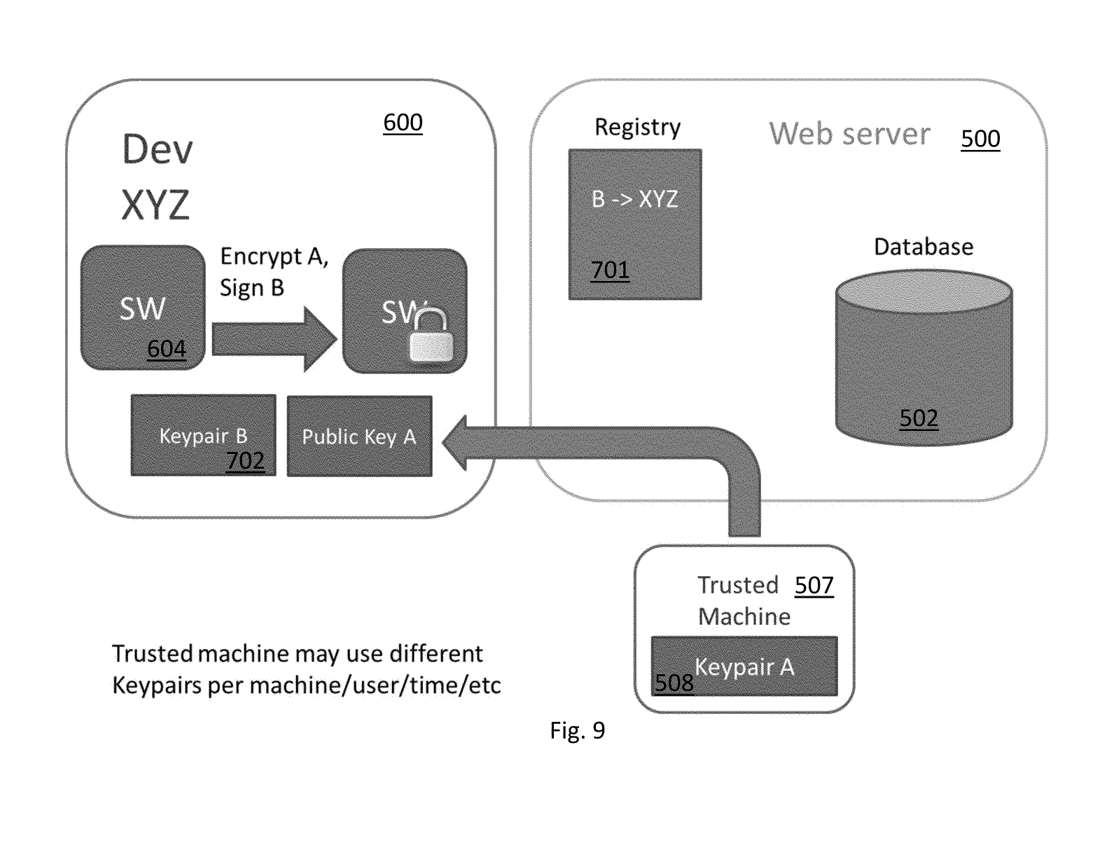

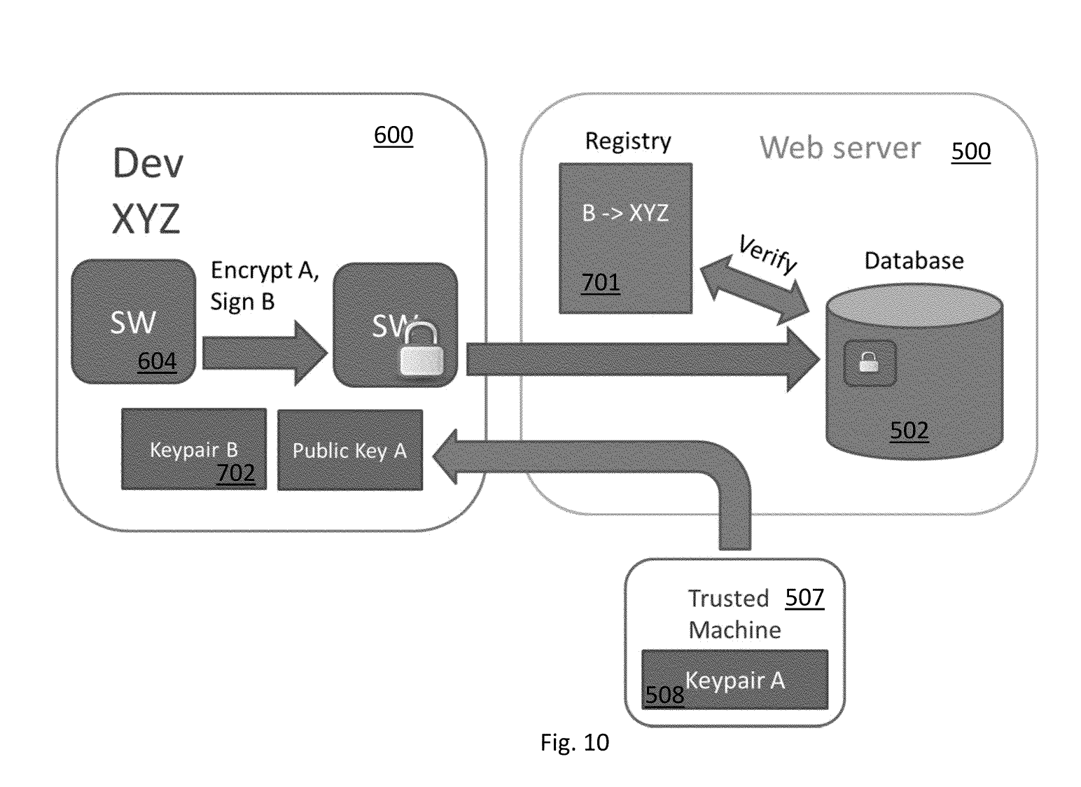

In a first illustrative Example 1, shown in FIGS. 6-10, the Developer XYZ 600 wants to develop hardware/software for the web store. Developer XYZ 600 first registers with the website so that their code can be identified. First, they generate a key pair 601 which Developer XYZ 600 will keep and protect (private part). Authentication of a developer pc and the server using SSL certificates 602 occurs. Next, Developer XYZ 600 submits the Public Key B 601 to the registry 500 as identifying their products. The web server 500 stores this key in the registry 501. Now, the web server 500 can verify that any products uploaded to the database are truly from who they say they're from. Developer XYZ 600 is then given the public key from Key pair A 508, to encrypt their product SW 604 before sending it. They encrypt their product with the public key A 508, then sign it with their private key B 601, creating a signed and encrypted package. Finally, Developer XYZ 600 sends this protected package 603 to the web server. The database verifies the source before storing the product SW 604.

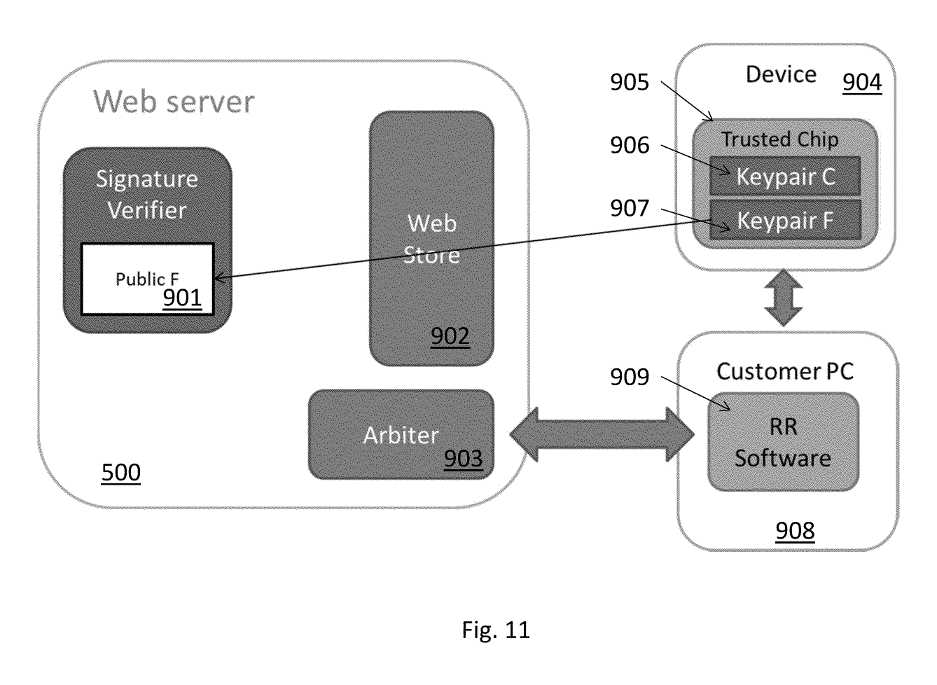

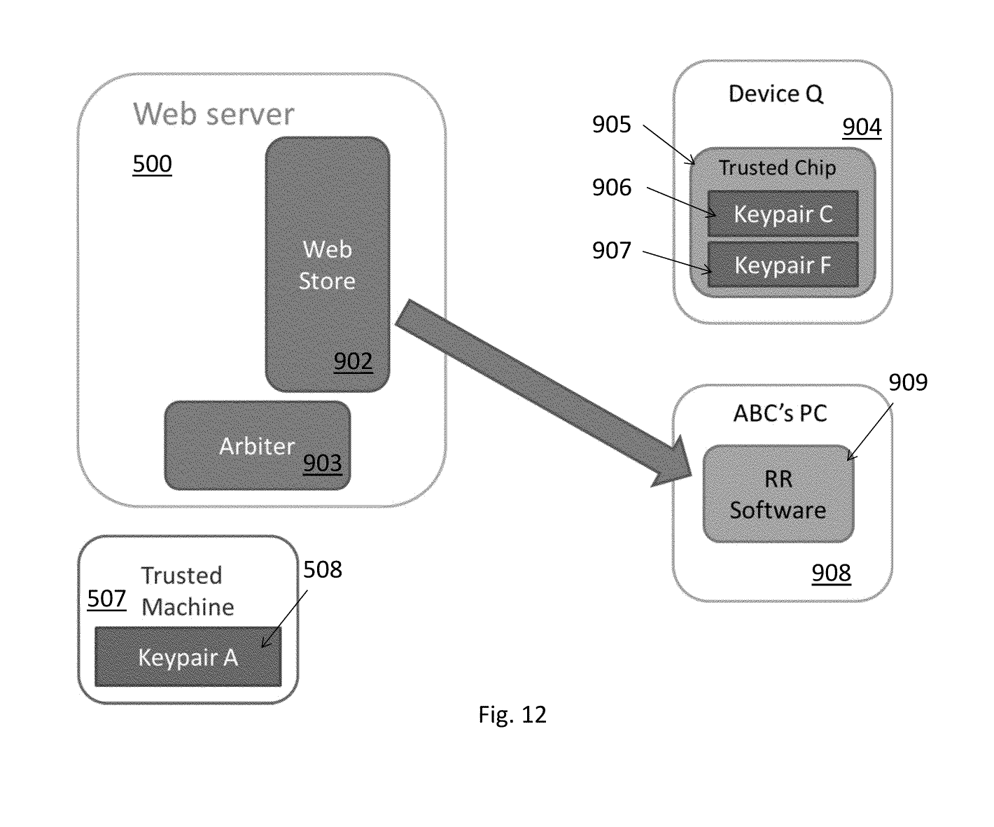

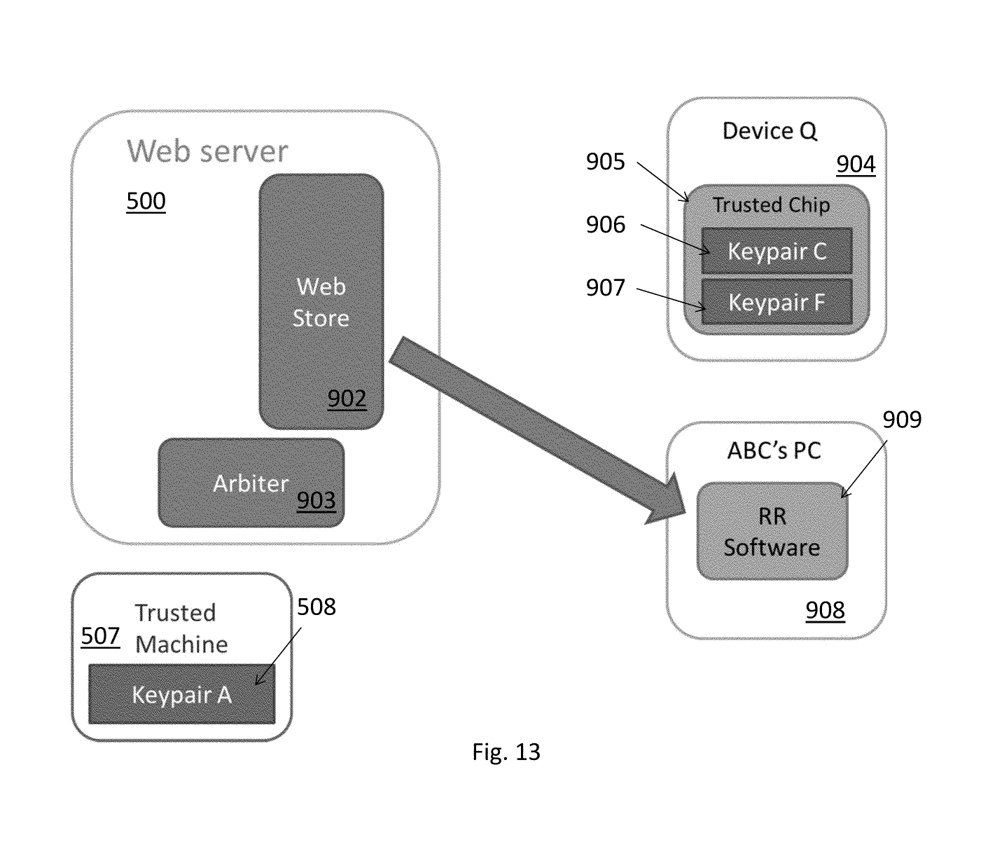

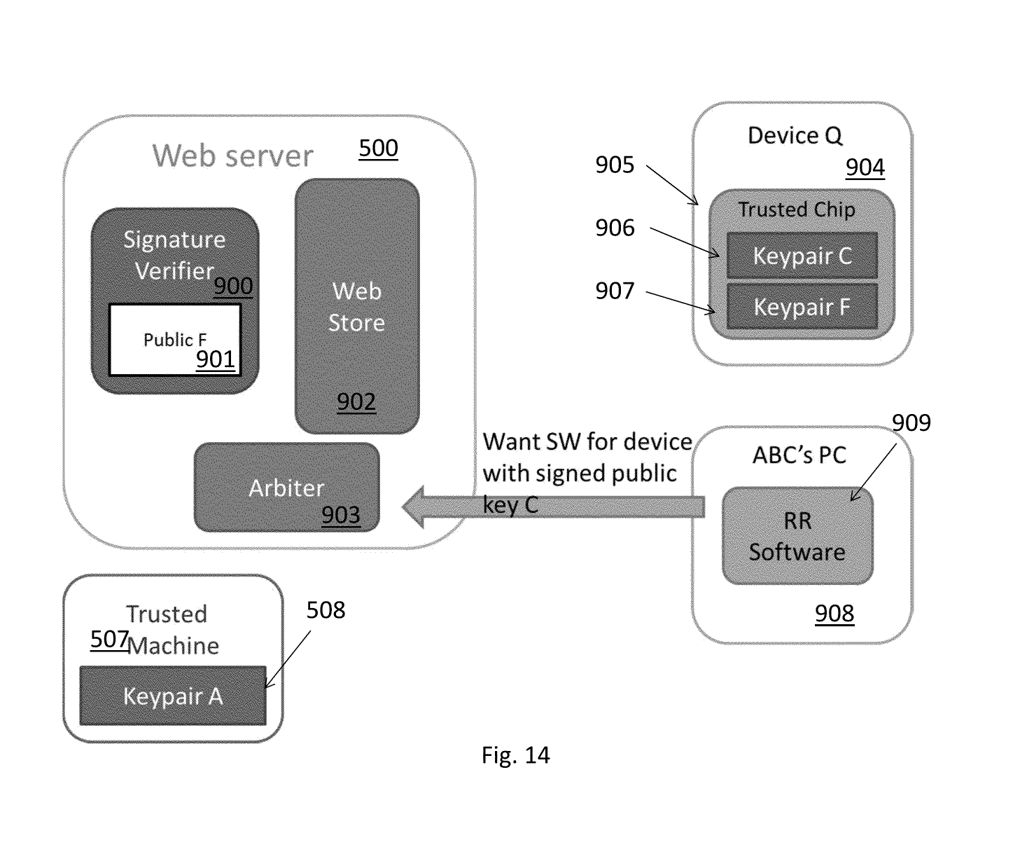

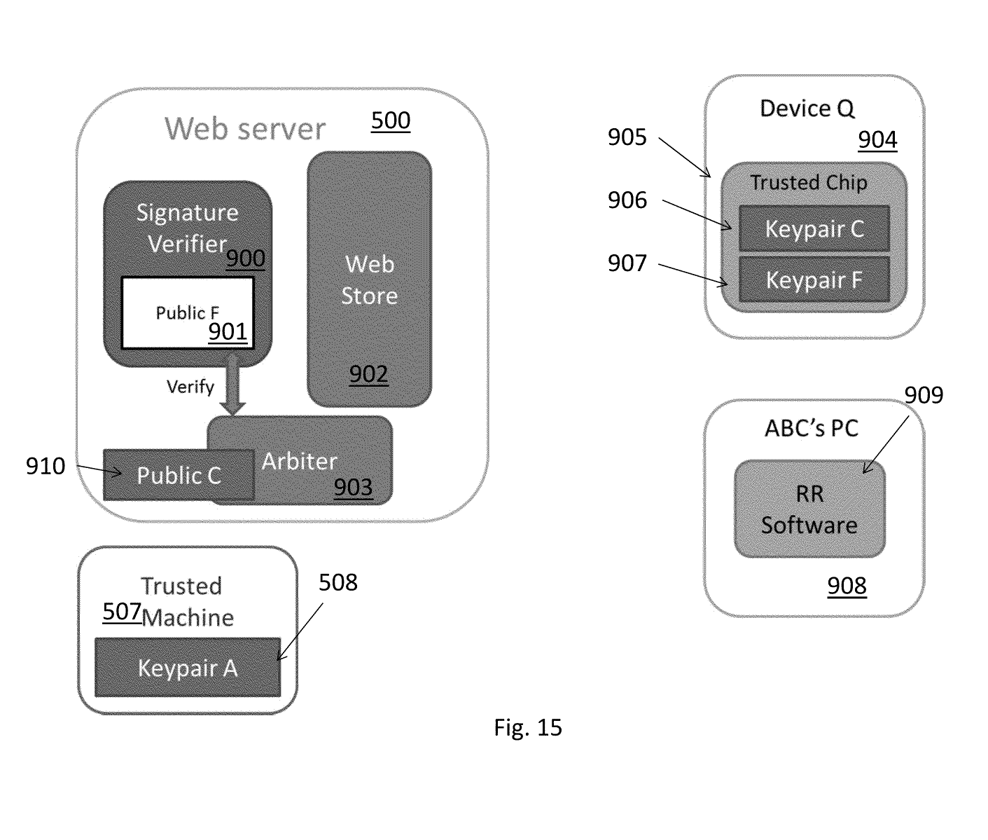

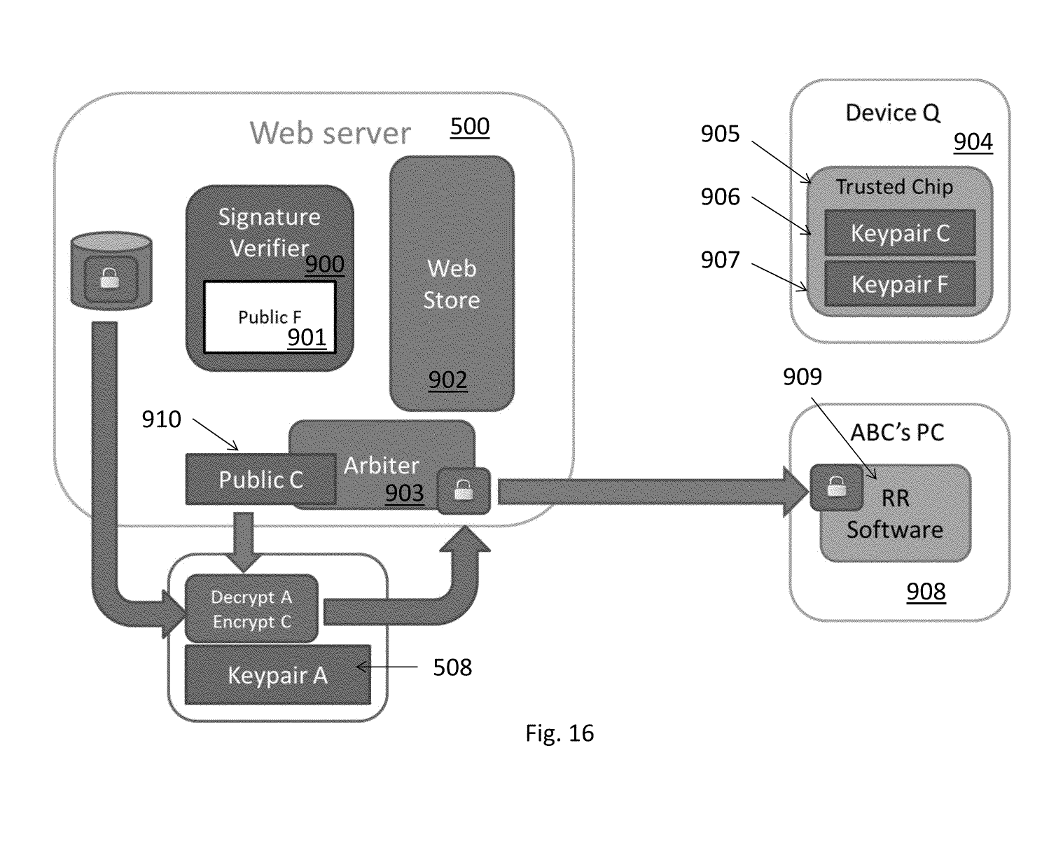

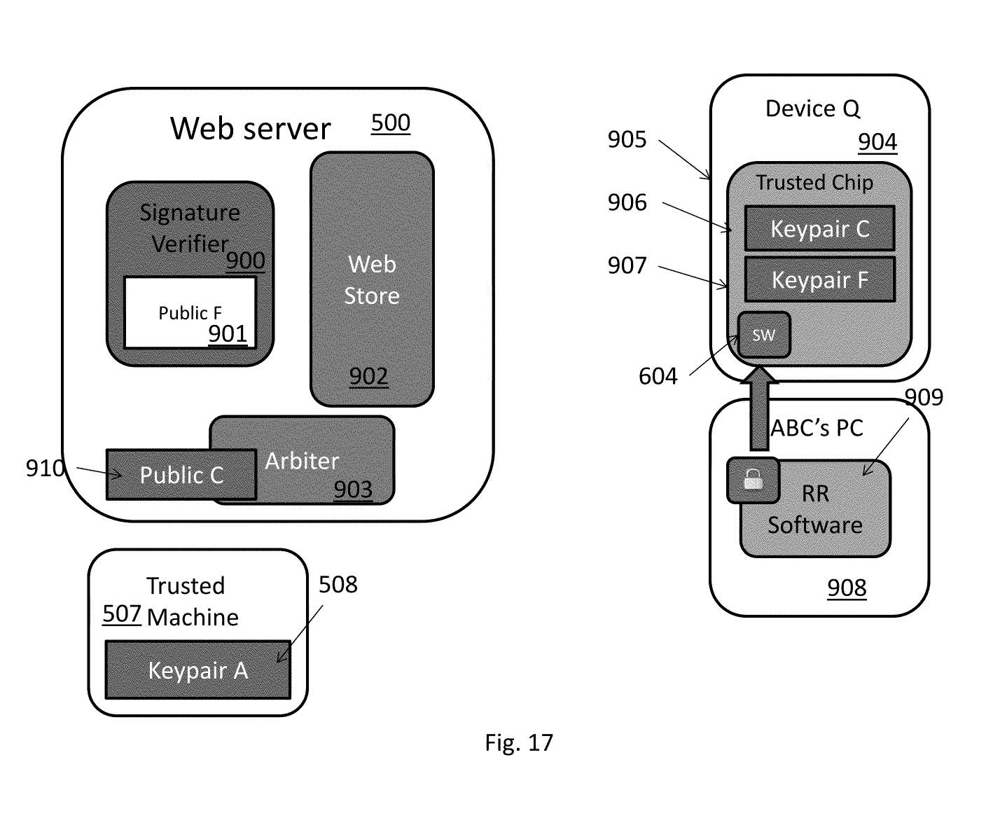

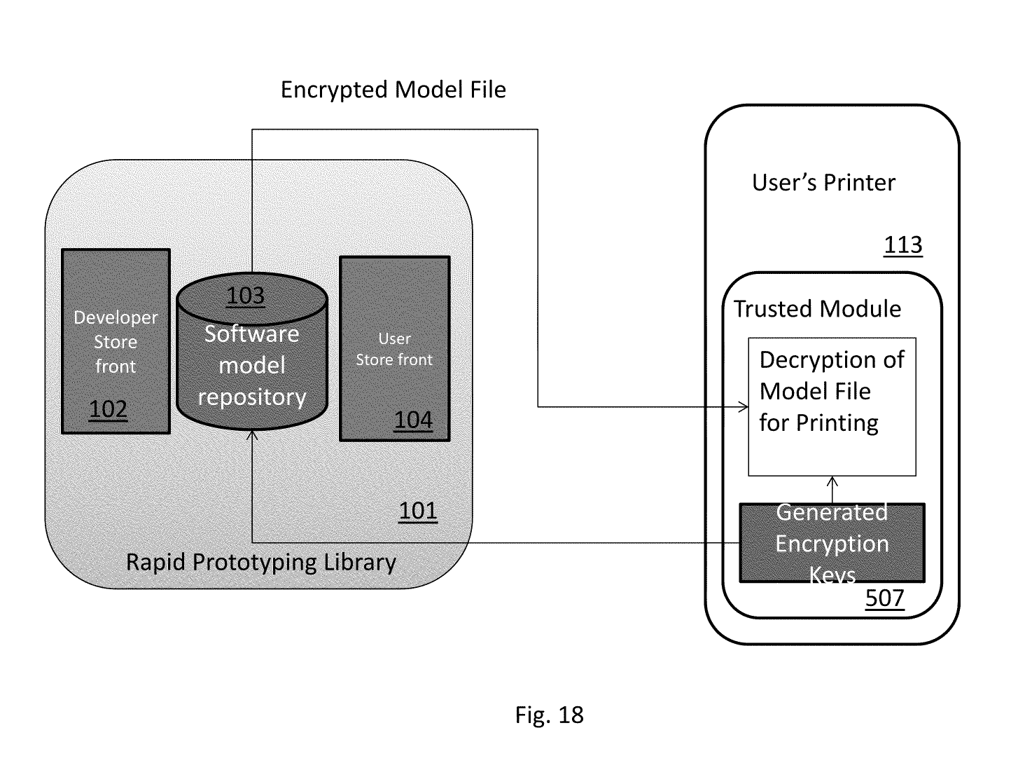

In a second illustrative example shown in FIGS. 11-18, the device side is explained. The device contains a trusted chip with two keys: Key pair F 907 used to verify the device, and Key pair C 906 to encrypt software for the device. Key pair F 907 is stored on the Signature Verifier 900 when the device is purchased. The web server 500 software runs on the PC which allows browsing of the web store 902 and downloading of encrypted software packages, using the Arbiter 903. Next, the Customer ABC browses the store and decides to purchase SW from XYZ (authentication of ABC is skipped). First, requests are assigned a serial number from the device to send to web server 500. Next the customer's computer requests software SW from the Arbiter 903, sending the signed serial number with the request. Next, the Arbiter 903 requests verification of the signature. If it matches, the Arbiter 903 will send on the device-specific encrypted package. Upon verification, Trusted Machine 507 decrypts SW with Private Key A 508, then re-encrypts with Public Key C 906. The package is sent to ABC. ABC uploads the software to the device, which decrypts is with Private Key C 906 in order to run.

The present invention also allows for keying the parts to the printer or to the micro-controls that work with the part. The 3D printer can add a code inside of the 3D printed material that identifies where the part has been printed by leaving gaps in the physical part to cut it apart and see where it was made. In the alternative, the 3D printer can embed holes into the part for later forensic use to obtain information about that part, in a Morse code or Braille fashion. The information can include the model, where printed, who purchased the printer, material, and printer serial number. The information can also include details so that the part can be traced back to the printing source.

All submissions from developers are verified before being added to the database 502. Products are only ever decrypted inside of the trusted machine 507 and on the actual device using the package. Packages are not sent to users without first verifying the end device. Each package distributed to a user are only usable on the specified device. Devices have two key pairs due to current COTS technology implementations.

In another embodiment of the present invention, printer authentication can be combined with the security system to enable a single time printing protocol. A trusted module 507 would be associated with the printer which comprises a random sequence generator. The printer 113 will generate the next keys required for printing and authorization using a Common Access Card (CAC). Next the server would encrypt the model with the keys generated by the trusted module of the printer 113 to allow for the printer to decrypt the keys and effectuate printing of the encrypted model. This would limit printing of the model file sent from the Rapid Prototyping Library 101 to the printer 113 to only that specific printer 113. If the model file was copied or hijacked during transmission, it would be unable to be executed or printed by any other 3D printer as there would be no printer authentication to unlock the file for use as any other printer, even with a trusted module would be unable to decrypt the file due to the missing encryption keys.

The system is set to run on a computing device. A computing device on which the present invention can run would be comprised of a CPU, Hard Disk Drive, Keyboard, Monitor, CPU Main Memory and a portion of main memory where the system resides and executes. Any general-purpose computer with an appropriate amount of storage space is suitable for this purpose. Computer Devices like this are well known in the art and are not pertinent to the invention. The system can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A method for communicating hardware designs and associated software, comprising the steps of:
providing a computer executing software for controlling a 3D printer;
providing a 3D printer;
authentication of one or more users by the computer;
authentication of a store;
authentication of one or more 3D printer devices; and
encryption of hardware models from the user to the store and the store to one or more 3D printer devices.

2. The method of claim 1, further comprising the step of
providing trusted modules at the 3D printer devices used to supply keys for the encryption.

3. The method of claim 1, further comprising the step of
providing trusted modules at the 3D printer devices used to supply keys for the encryption; and
providing trusted modules at the non-printable 3D parts and 3D printed parts used to supply keys for the encryption.

5. The method of claim 1, further comprising the step of
using cryptography to key the models to the 3D printer devices being deployed.

6. The method of claim 1, further comprising the step of
using cryptography to protect the models so they can only be used by those printed 3D parts.

7. The method of claim 1, wherein
a webserver is comprised of a registry, database, web store, arbiter, and signature verifier with device public keys.

8. The method of claim 7, wherein
an external trusted machine provides a first key pair to the server system;
the database contains encrypted copies of developer software/models, using the Trusted Machine to encrypt;
the Signature Verifier verifies that devices requesting code are truly safe devices provided from a third party;
the Trusted Machine provides a first key pair “A” used to encrypt and decrypt entries into the database safely;
a trusted module is associated with the printer which comprises a random sequence generator;
the 3D printer generates keys required for printing and authorization using a Common Access Card (CAC); and
the server encrypts the model with the keys generated by the trusted module of the printer to allow for the printer to decrypt the keys and effectuate printing of the encrypted model.

9. The method of claim 1, further comprising the step of
keying the parts to the printer or to the micro-controls that work with the part.

10. The method of claim 1, further comprising the step of
adding a code inside of the 3D printed material that identifies where the part has been printed by leaving gaps in the physical part to cut it apart and see where it was made.

11. The method of claim 1, further comprising the step of
embedding holes into the part for later forensic use to obtain information about that part.

12. The method of claim 11, wherein the information includes the model, where printed, who purchased the printer, material, and printer serial number.

13. The method of claim 11, wherein the information includes can be traced back to the printing source.

14. A Method to Protect Deployable Rapid On-Site Manufacturing 3D Printing Systems, comprising:
a webserver comprised of a registry, database, web store, arbiter, and signature verifier with device public keys;
a trusted machine provides a first key pair is external to the server system;
the registry holds developer registration information, including public key;
the database contains encrypted copies of developer software/models, using the Trusted Machine to encrypt;
the Signature Verifier is used to verify that devices requesting code are truly safe devices provided from a third party;
the Trusted Machine provides a first key pair “A” used to encrypt and decrypt entries into the database safely;
the Arbiter is the software which handles software requests, encryption and signature commands, and database functions;
a trusted module\associated with the printer which comprises a random sequence generator;
the 3D printer generates the keys required for printing and authorization using a Common Access Card; and
the server encrypting the model with the keys generated by the trusted module of the printer to allow for the printer to decrypt the keys and effectuate printing of the encrypted model.

15. The method of claim 14, further comprising the step of providing a Web Store that is the web frontend where users may browse and download new models/software; and

16. The method of claim 14, further comprising the step of limiting printing of the model file sent from the Rapid Prototyping Library to the printer to only that specific printer.
